(19) United States
(12) Patent Application Publication
(10) Pub. No.: US 2021/0125252 A1
(43) Pub. Date: Apr. 29, 2021

(54) Filtering Apparatus and Method

(71) Applicant: Assured Performance Network, Laguna Hills, CA (US)

(72) Inventor: Scott Edwin Biggs, Polson, MT (US)

(21) Appl. No.: 16/664,424

(22) Filed: Oct. 25, 2019

(51) Int. Cl. G06Q 30/06; G06F 16/9537; G06F 16/9538; G07C 5/00

(52) U.S. Cl. CPC G06Q 30/0627; G07C 5/008; G06F 16/9538; G06F 16/9537

(57) ABSTRACT

A control circuit receives identifying information for a given vehicle and information that identifies damaged vehicular shell/unibody features of that vehicle. The control circuit also determines a relevant geographic location that corresponds to given vehicle. The control circuit uses the foregoing information to identify special circumstances that characterize repairability requirements for the vehicular shell/unibody features of the vehicle. Using the previously determined relevant geographic location along with these special circumstances, the control circuit filters information regarding available vehicular repair facilities to thereby identify at least one vehicular repair facility that can accommodate the plurality of special circumstances while also meeting a geographic convenience criterion. The control circuit transmits displayable information that includes identifying content regarding the at least one vehicular repair facility.

### TECHNICAL FIELD

These teachings relate generally to information filtering and more particularly to selecting at least one resource.

### BACKGROUND

As long as there have been automobiles, there have been collisions involving those automobiles that cause vehicular damage (the very first automobile accident reputedly occurred in 1891 when a very early gasoline-powered automobile ironically struck a hitching post). Over time a corresponding industry developed that specialized in repairing vehicular collision-based damage.

By at least one measure, however, modern automobiles are as far removed from those early vehicles as those early vehicles were removed from that hitching post. Many modern vehicles, for example, are carefully designed to protect occupants during a collision. In many cases this includes the use of a so-called unibody. With unibody construction, rather than employing a vehicular body that is mounted on a frame, the chassis and bodywork are integrated with one another. Unibody construction typically includes design features that allow the unibody to crumple in a particular manner during a collision to thereby help protect the occupants. In particular, the unibody structure of the vehicle will channel forces imparted by a collision around the passenger compartment to thereby protect the occupants of that passenger compartment.

While offering numerous benefits, unibody construction greatly complicates repairs. This at least partly results from the fact that a spot repair to a part of the unibody, while possibly appearing to be cosmetically sufficient, may nevertheless constitute a break in the overall structural integrity of the unibody. In the event of a subsequent collision, that break can foil the intended force-directing behavior of the unibody and thereby result in otherwise avoidable injury to an occupant.

Modern vehicles present other collision-based repair challenges as well. As one example, the vehicular shell will typically include sensors that are disposed within one or more unibody components. These sensors can be critical components in on-board systems designed to improve safety. Such sensors can include but are not limited to lidar and radar transducers, cameras, and various proximity sensors.

As another example, unibody components may be formed of materials that may require special handling and/or installation techniques or tools. For example, many modern vehicles have special/exotic metal compositions in their cosmetic exterior panels and/or in the inner structure of the vehicle. Some of the metals in the inner structure have different degrees of strength all within a single part that might need to be repaired or replaced. A repair technician needs to be able to identify the issues that attend such a circumstance and address them appropriately. That capability comes only with proper training. In addition, some metals, like aluminum, can require an isolated repair area to avoid rapid erosion that can occur in a mixed-metals work environment.

As a result, many collision repair facilities are not necessarily equipped to handle all collision-based repairs for all modern vehicles. Depending upon the vehicular shell/unibody features that characterize a particular vehicle, a given facility may lack the correct replacement parts, necessary tools to correctly replace damaged parts and/or to test whether a replaced part is operating correctly, proper work areas, and/or properly trained repair personnel. Acerbating the challenge of vetting and identifying a proper repair facility for a given vehicle is that the responsible party themselves will typically be without sufficient information to understand the requisite requirements to ensure a proper repair.

### BRIEF DESCRIPTION OF THE DRAWINGS

The above needs are at least partially met through provision of the filtering apparatus and method described in the following detailed description, particularly when studied in conjunction with the drawings, wherein:

FIG. 1 comprises a block diagram as configured in accordance with the prior art;

FIG. 2 comprises a flow diagram as configured in accordance with various embodiments of these teachings;

FIG. 3 comprises a block diagram as configured in accordance with various embodiments of these teachings; and

FIG. 4 comprises a timing diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments provide for identifying a vehicular shell/unibody repair facility well suited to effect a particular repair to a particular given vehicle.

By one approach a control circuit (operably and communicatively coupled to a network interface) carries out a number of activities in support of the foregoing. For example, this control circuit can be configured to receive identifying information for a given vehicle and information that identifies damaged vehicular shell/unibody features of the given vehicle. The control circuit can further be configured to determine a relevant geographic location that corresponds to this given vehicle.

By one approach the control circuit is configured to then use that identifying information and the information that identifies the damaged vehicular shell/unibody features of the given vehicle to identify a plurality of special circumstances that characterize repairability requirements for the vehicular shell/unibody features of the given vehicle. Using the previously determined relevant geographic location along with this plurality of identified special circumstances, the control circuit filters information regarding a plurality of available vehicular repair facilities to thereby identify at least one vehicular repair facility that can accommodate the plurality of special circumstances while also meeting a geographic convenience criterion.

These teachings will accommodate including both unibody components and sensors disposed within unibody components amongst the above-mentioned vehicular shell/unibody features. That said, by one approach the aforementioned vehicular shell/unibody features exclude powertrain components, window glass, tires and corresponding wheels, mechanical systems, and so forth that are not a part of the shell or the unibody construction of the vehicle.

By one approach the control circuit is further configured to transmit displayable information that includes identifying content regarding the at least one vehicular repair facility that can accommodate the plurality of special circumstances and that meets the geographic convenience criterion.

These teachings are highly flexible in practice and will accommodate modifications and/or supplemental considerations as desired. As one example in these regards, the control circuit can be further configured to identify the vehicular repair facility as a further function of one or more additional selection criteria. Examples in the foregoing regards include but are not limited to service hours for the facility, replacement vehicle availability, vehicle pickup service availability, repaired-vehicle return service availability, repair parts availability, estimated repair time, quality of service ratings and records, and so forth.

So configured, a likely large number of available vehicular repair facilities that might otherwise presumptively appear available and suitable to effect a particular repair to one or more damaged vehicular shell/unibody features of a particular vehicle can be filtered to eliminate candidate facilities that are wanting in one or more respects as regards being able to effect a satisfactory repair of a particular damaged vehicular shell/unibody features. So configured, these teachings can save time and resources that might otherwise be expended to locate a suitable repair facility. Perhaps more importantly, these teachings can help to avoid a “repair” that may appear cosmetically satisfactory but that in fact impairs the future intended response of the vehicle's unibody to a future collision. In that regard these teachings can help avoid future injury or death to occupants of the repaired vehicle.

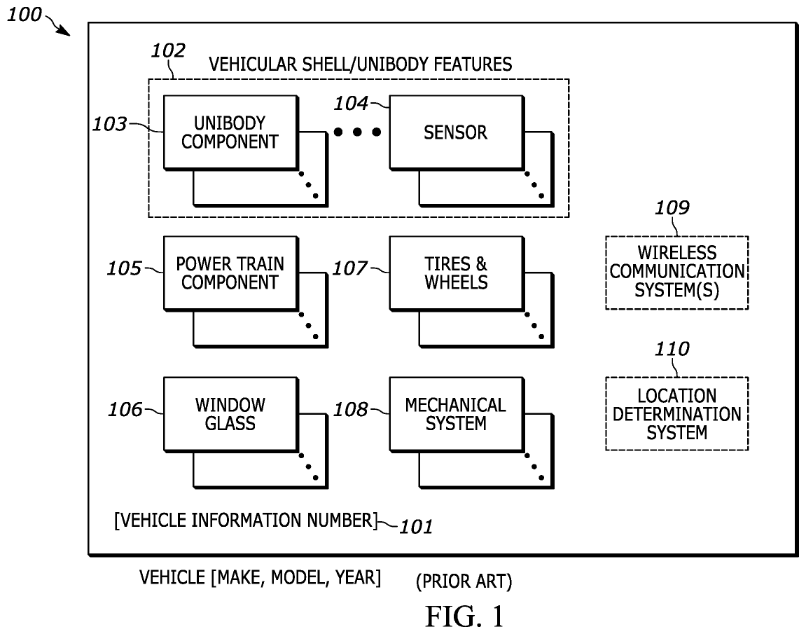

These and other benefits may become clearer upon making a thorough review and study of the following detailed description. Referring now to the drawings, and in particular to FIG. 1, it may be helpful to begin with a general characterization of a modern terrestrial vehicle.

A modern vehicle 100 will typically have a corresponding make, model, and year. The “make” refers to the manufacturer while the “model” refers to a model identifier ascribed by the manufacturer. The “year” typically refers to the model year which may or may not correspond to the calendar year in which the vehicle was manufactured.

In many cases the vehicle 100 will also have a corresponding vehicle information number (VIN) 101. A VIN is a unique code, including a serial number, used by the automotive industry to identify individual motor vehicles, towed vehicles, motorcycles, and so forth as defined in ISO 3779 (content and structure) and ISO 4030 (location and attachment). The foregoing identifying information is well understood in the art and requires no further elaboration here.

Pertinent to the present teachings, the vehicle 100 includes a number of vehicular shell/unibody features 102. These include a plurality of unibody components 103 and often a plurality of sensors 104 that are each disposed within a corresponding unibody component 103. (In many cases the processor that receives information from such sensors is not disposed within a unibody component but instead is disposed elsewhere in the vehicle 100.) Some of the unibody components 103 form a fully integrated body structure that constitutes a singular load-carrying unit that handles the loads experienced by the vehicle including forces from driving, cargo loads, and forces experienced during a collision. Such components are often welded together and/or are formed or cast as whole sections as one piece. The vehicular shell include the vehicle's outer skin and panels that are also often load-bearing per the unibody paradigm.

The vehicle 100 also includes any number of components that are not vehicular shell/unibody features. Some illustrative examples include, but are not limited to, powertrain components 105, window glass 106, tires and wheels 107, mechanical systems 108, one or more optional wireless communication systems 109 (such as cellular telephony platforms, Wi-Fi platforms, and Bluetooth platforms, to note but a few examples), and one or more optional location determination systems 110 such as systems that make use of the global positioning system (GPS). Such components are all well understood in the art and are well understood to not constitute a part of the vehicular shell/unibody of the vehicle 100.

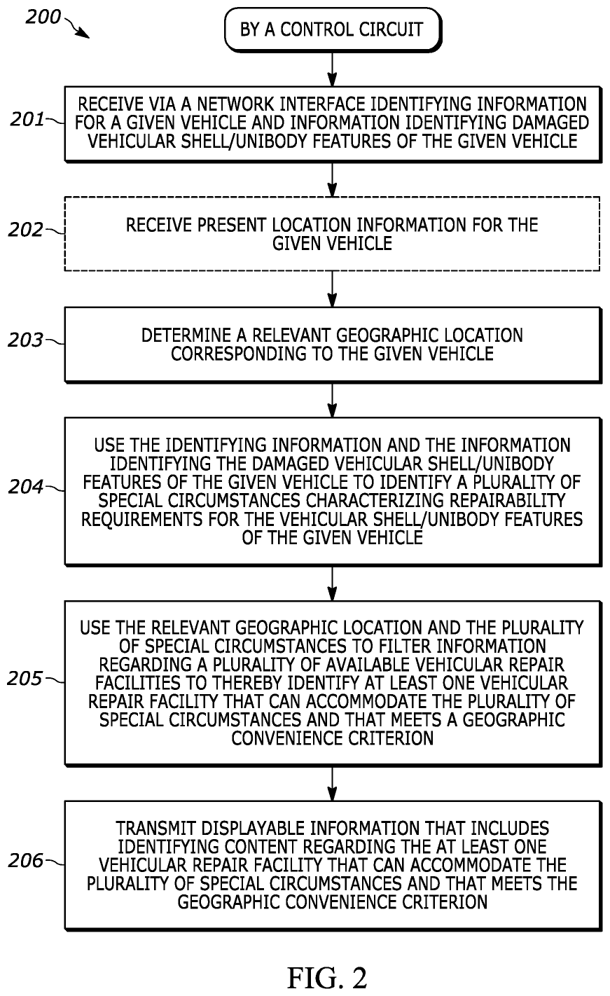

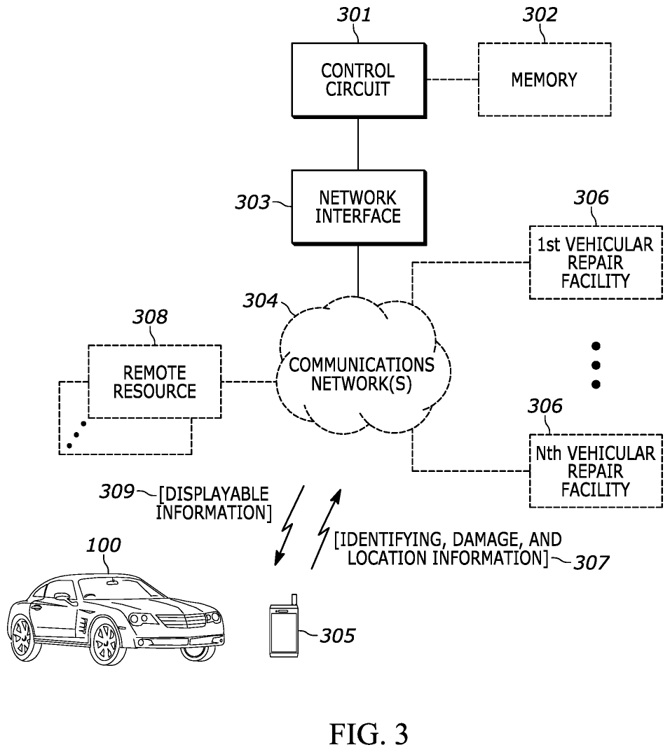

Referring now to FIG. 2, a process 200 that comports with many of these teachings will be described. In this illustrative example a control circuit carries out at least some of the described activities of this process 200. FIG. 3 presents an illustrative application setting that includes such a control circuit 301.

With continued momentary reference to FIG. 3, being a “circuit,” the control circuit 301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 301 is configured (for example, by using corresponding programming as will be well understood by those skilled in the art) to carry out one or more of the steps, actions, and/or functions described herein.

By one optional approach the control circuit 301 operably couples to an optional memory 302. This memory 302 may be integral to the control circuit 301 or can be physically discrete (in whole or in part) from the control circuit 301 as desired. This memory 302 can also be local with respect to the control circuit 301 (where, for example, both share a common circuit board, chassis, power supply, and/or housing) or can be partially or wholly remote with respect to the control circuit 301 (where, for example, the memory 302 is physically located in another facility, metropolitan area, or even country as compared to the control circuit 301).

In addition to vehicle, repair information, and repair facility information as may be desired or appropriate, this memory 302 can serve, for example, to non-transitorily store the computer instructions that, when executed by the control circuit 301, cause the control circuit 301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

In this example the control circuit 301 also operably couples to a network interface 303 that itself communicatively couples to one or more communications networks 304 (such as an intranet that comprises a part of the vehicle 100, a cellular telephony data network, and/or the Internet). So configured the control circuit 301 can communicate with other elements via the network interface 303. Examples of such elements include but are not limited to one or more user devices 305 (such as a so-called smart phone or a native communications platform that comprises a part of the aforementioned given vehicle 100), any of a variety of sensors or other components that are a part of the vehicle 100 itself, and/or one or more vehicular repair facilities 306.

As yet another example in these regards, the control circuit 301 may also communicatively couple to one or more remote resources 308. These remote resources 308 may serve as reliable sources of information regarding the various components and systems that comprise various vehicles, maintenance, installation, and/or repair instructions and/or requirements, information regarding vehicular repair facilities, and so forth. These remote resources 308 may be controlled and/or operated by any of a variety of public and private entities including vehicle manufacturers, standards bodies, consumer product ratings services, and so forth.

With continued reference to both FIGS. 2 and 3, at block 201 the control circuit 301 receives (via, for example, the aforementioned network interface 303) a message 307 containing identifying information for the given vehicle 100 as well as information that identifies damaged vehicular shell/unibody features of the given vehicle 100. (Those skilled in the art will understand that this “message” may assume any of a variety of forms and hence may be a single inclusive communication or may instead comprise a series of logically and physically discrete communications that in their aggregate constitute the “message.”)

This message 307 may be sourced by a user such as the vehicle owner. By another approach the vehicle 100 may itself automatically instigate transmission of the message 307. (This vehicular-sourced automatic transmission may be responsive, for example, to self-detection of phenomena that are indicative of a collision. Such phenomena may be detected using, for example, camera information, radar/lidar information, proximity sensor information, accelerometer information, and so forth.) Being flexible in practice, these teachings will accommodate other approaches in these regards. For example, this message 307 may be sourced by a representative of an insurance company or a representative of a roadside assistance service such as AAA.

By one approach the aforementioned identifying information for the given vehicle 100 comprises a 17-character VIN specific to the given vehicle 100. By another approach, the identifying information may serve to identify the make, model, and year information for the given vehicle in a format other than a VIN.

The information that identifies the damaged vehicular shell/unibody features of the given vehicle can assume any of a variety of useful formats. By one approach the specific damaged features are identified using technically specific and/or colloquial expressions. By another approach, in lieu of the foregoing or in combination therewith, the damaged area of the vehicle 100 is simply generally described. For example, the information may simply state that the “front end” of the vehicle 100 is damaged, or that damage occurred to the “front driver side quadrant” of the vehicle 100. By yet another approach, and again in lieu of the foregoing or in combination therewith, imagery of the damaged area may comprise part or all of the aforementioned message. Such imagery may constitute one or more digital photographs (which may be augmented with added graphic elements to point to particular areas of the vehicle) or may constitute, for example, a line drawing of the vehicle to which annotations have been added to identify damaged areas of the vehicle 100.

At optional block 202, if desired, this process 200 further provides for the control circuit 301 receiving (for example, via the network interface 303) present location information relative to the given vehicle 100. By one approach this location information can be provided directly from the vehicle 100 when the latter has a location determination system 110 and a suitable wireless communication system 109 as described above. By another approach, this location information can be provided by the user device 305 when the latter has its own location determination capability (for example, a GPS capability). By yet another approach, this location information can be provided as an address or map coordinates that are entered and/or otherwise selected by a user (for example, by entering the address in a text field or by clicking on a particular area on a displayed map on the user device 305).

At block 203 the control circuit 301 determines a relevant geographic location corresponding to the given vehicle 100. When the control circuit 301 receives present location information for the given vehicle 100 as described above, this step can comprise determining the relevant geographic location corresponding to the given vehicle 100 as a function of the present location information so received.

These teachings will accommodate other approaches in these regards, however. For example, the control circuit 301 may have access to profile information for the vehicle 100 and/or the corresponding owner or user of that vehicle 100, which profile information specifies the geographic location to be used as the relevant geographic location. By way of illustration, this geographic location specified in a corresponding profile may be a residential address that corresponds to where the vehicle 100 is ordinarily garaged or a business address for the vehicle's usual driver.

At block 204, the control circuit 301 uses the aforementioned identifying information that corresponds to the given vehicle 100 as well as the aforementioned information that identifies the damaged vehicular shell/unibody features of the given vehicle 100 to identify a plurality of special circumstances that characterize repairability requirements for the vehicular shell/unibody features of the given vehicle 100. As noted earlier, the vehicular shell/unibody features can comprise vehicular shell components, unibody components, and sensors disposed within shell or unibody components but exclude other vehicular features such as powertrain components, window glass, tires and corresponding wheels, unrelated mechanical systems, and so forth.

The aforementioned special circumstances that characterize repairability requirements for the vehicular shell/unibody features of the given vehicle 100 can include any relevant circumstance that is necessary and/or advisable to effect an appropriate repair. By one approach the special circumstances can include identifying and noting particular materials used to form any of the vehicular shell/unibody features, which materials may themselves dictate a need for specialized tools, facilities, and or training to assure proper handling and/or installation. Other special circumstances can include such things as the use and/or availability of proper replacement parts, the availability of proper diagnostic equipment and trained personnel to correctly use that equipment, proper testing equipment to test the efficacy of a particular repair, and requisite training to properly effect each and every aspect of the repair.

It should be particularly noted that each and every vehicular shell/unibody feature can have its own corresponding special circumstances due to uniquely applicable repairability requirements. Accordingly, these teachings will accommodate identifying individually each and every such special circumstances to thereby yield an aggregated collection of special circumstances that collectively represent the repairability requirements to effect a complete repair of all of the damaged vehicular shell/unibody features of the given vehicle 100.

At block 205, the control circuit 301 uses the aforementioned relevant geographic location and the aforementioned plurality of special circumstances to filter information regarding a plurality of available vehicular repair facilities to thereby identify at least one vehicular repair facility that can accommodate the plurality of special circumstances and that also meets a geographic convenience criterion.

By one approach, this filtering serves to remove any vehicular repair facilities that are unable to meet the repair requirements occasioned by each and every one of the identified special circumstances. By another approach, this filtering can serve to remove any vehicular repair facility that is unable to meet at least some predetermined percentage of the repair requirements. For example, this filtering can remove any vehicular repair facility that cannot meet at least 75 percent of the repair requirements. (The latter approach may be useful when no one reasonably convenient repair facility is itself capable of properly completing the entire repair of the given vehicle 100.)

The aforementioned geographic convenience criterion can comprise, for example, a particular distance beyond which candidate repair facilities are excluded from consideration. As an illustrative example in these regards, candidate repair facilities that are more than 20 miles from the aforementioned relevant geographic location may be filtered out. (These teachings will accommodate various approaches in these regards. For example, a particular distance of X miles may refer to an area circumscribed by a circle centered on the relevant geographic location and having a radius of X. Or, if desired, that particular distance of X miles may refer to a maximum driving distance.)

In lieu of the foregoing, or in combination therewith, the geographic convenience criterion can be specified in terms of political boundaries. For example, the geographic convenience criterion can specify one or more municipalities (that may or may not be adjacent to one another as desired), counties, states, or the like.

These teachings will also accommodate identifying the at least one vehicular repair facility as a further function of at least one additional selection criteria. Examples in these regards include, but are not limited to, service hours of the candidate repair facilities, replacement vehicle availability (i.e., a vehicle to temporarily replace the vehicle to be repaired while waiting for the repair to conclude), vehicle pickup service availability, repaired-vehicle return service availability, repair parts availability, estimated repair time, and/or quality of service records and ratings.

At block 206, the control circuit 301 transmits (for example, via the network interface 303) displayable information 309 that includes identifying content regarding the at least one vehicular repair facility 306 that can accommodate the plurality of special circumstances and that meets the geographic convenience criterion. This identifying content can vary with the needs of the application setting. Examples of identifying content include, but are not limited to, a telephone number, a street address, an active link that leads/points to, for example, an Internet site for the vehicular repair facility, and so forth.

In addition to the foregoing identifying content, the control circuit 301 can also transmit additional information regarding either the corresponding vehicular repair facility and/or certain specifics regarding the vehicular damage regarding which the user/driver may be unaware. Such additional information can also include information regarding present availability of repair parts, service hours, replacement vehicle availability and vehicle pickup service availability, estimated repair time, quality of service records, and so forth.

If desired, the information provided by the control circuit 301 can also include a provided user interface by which the user/recipient can select a particular vehicular repair facility. This user interface may comprise, for example, a user-assertable soft button by which the user can “select” a particular vehicular repair facility. Upon making this selection, a corresponding selection message can be transmitted to the control circuit 301 which then acts to contact the selected vehicular repair facility to begin the process of repairing the damaged vehicle. This process can include arranging to deliver the damaged vehicle to the facility, pre-ordering necessary parts that may not already be immediately available to the facility that will be required to effect the repair, obtaining repair instructions and/or training/certification as may be necessary to effect the repair, and so forth.

So configured, these teachings can greatly facilitate repairing vehicular damage that includes the vehicular shell and/or unibody features of a given vehicle. In particular, by filtering a set of otherwise apparently available vehicular repair facilities as described herein, a vehicular owner or other responsible party can be assured that the vehicular repair facility selected to effect repairs to a given damaged vehicle is not only relatively geographically convenient but also well-suited to make repairs in a way that should assure continued efficacy of the vehicle's unibody construction and sensors deployed within that unibody.

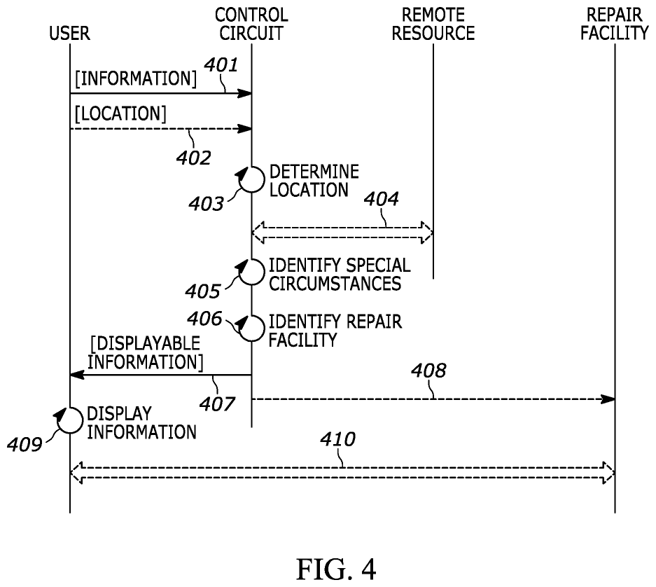

FIG. 4 presents an illustrative example in these regards. It will be understood that the specifics of this example are intended to serve an illustrative purpose and are not intended to suggest any particular limitations in these regards.

This example begins when a user transmits a message 401 to the aforementioned control circuit 301 that at least contains identifying information for a given vehicle, along with information that identifies damaged vehicular shell/unibody features of the given vehicle 100. This message 401 may also include (or the user may separately transmit another message 402 that includes) present location information for the given vehicle. (It will be understood that this “user” may be a person or other representative entity, but may also be or comprise the damaged vehicle itself.)

The control circuit 301 then determines 403 a relevant geographic location that corresponds to the given vehicle 100. In this example the user did transmit present location information for the given vehicle 100 and the control circuit 301 utilizes that present location information to determine this relevant geographic location; i.e., a present location for the damaged vehicle 100.

Using the identifying information for the vehicle along with the information that identifies the damaged vehicular shell/unibody features of the given vehicle, the control circuit 301 may optionally communicate 404 with one or more remote resources 308 to obtain information to then help identify 405 any special circumstances that characterize repairability requirements for the damaged vehicular shell/unibody features of the given vehicle 100. Utilizing appropriate remote resources 308 can both help to avoid a need to locally store and maintain such information while also helping to ensure that the utilized information is both accurate and up-to-date.

Using the identified special circumstances, the control circuit 301 then filters information regarding a plurality of available vehicular repair facilities (which information the control circuit 301 may also have obtained from one or more of the remote resources 308) to thereby identify 406 at least one vehicular repair facility that can accommodate the identified special circumstances while also meeting at least one applicable geographic convenience criterion.

The control circuit 301 then transmits content 407 to the user, which content comprises displayable information that includes identifying content regarding the at least one vehicular repair facility that can accommodate the plurality of special circumstances and that meets the geographic convenience criterion. If desired, the control circuit 301 can also transmit a message 408 to, for example, the identified one or more vehicular repair facilities to thereby alert the latter as to the potential need to repair this particular vehicle.

The displayable information is then displayed 409 at the user using, for example, display capabilities of a user device 305 and/or of the vehicle 100 itself. This displayed information then permits and empowers the user to take informed actions to facilitate a proper repair of the damaged vehicle 100. If desired, the user may then engage in one or more direct or indirect communications 410 with a selected repair facility during which a further exchange of information can occur, arrangements can be made to retrieve and repair the vehicle, and so forth.

It is known in the art to identify available vehicular repair facilities as a function of geographic location. The applicant has determined that such approaches do not take into account the increasingly challenging issues presented by vehicular unibody manufacturing techniques. The teachings set forth herein continue to accommodate geographical considerations while also employing an understanding of unibody-related concerns as filtering criteria to thereby help ensure that a damaged vehicle is not only repaired, but repaired in a way that preserves the intended and designed-in safety operability of the vehicle's unibody.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. As but one example in these regards, this process 200 can serve to identify one or more available vehicular repair facilities that are to be found within a first distance of the relevant geographic location and to also then separately identify one or more available vehicular repair facilities that are to be found further way but within a second distance of the relevant geographic location. As another salient example, the aforementioned control circuit 301 may itself be a part of or otherwise be installed within the vehicle 100 itself.

What is claimed is:

1. An apparatus configured to identify a vehicular shell/unibody repair facility comprising:
a network interface configured to communicatively couple to at least one communications network;
a control circuit operably coupled to the network interface and configured to:
receive via the network interface identifying information for a given vehicle and information identifying damaged vehicular shell/unibody features of the given vehicle;
determine a relevant geographic location corresponding to the given vehicle;
use the identifying information and the information identifying the damaged vehicular shell/unibody features of the given vehicle to identify a plurality of special circumstances characterizing repairability requirements for the vehicular shell/unibody features of the given vehicle;
use the relevant geographic location and the plurality of special circumstances to filter information regarding a plurality of available vehicular repair facilities to thereby identify at least one vehicular repair facility that can accommodate the plurality of special circumstances and that meets a geographic convenience criterion;
transmit via the network interface displayable information that includes identifying content regarding the at least one vehicular repair facility that can accommodate the plurality of special circumstances and that meets the geographic convenience criterion.

2. The apparatus of claim 1 wherein the identifying information for the given vehicle comprises a 17-character vehicle identification number (VIN).

3. The apparatus of claim 1 wherein the identifying information for the given vehicle comprises make, model, and year information for the given vehicle.

4. The apparatus of claim 1 wherein the control circuit is further configured to receive, via the network interface, present location information for the given vehicle and wherein the control circuit is configured to determine the relevant geographic location corresponding to the given vehicle as a function of the present location information.

5. The apparatus of claim 4 wherein the present location information comprises global positioning system (GPS) information.

6. The apparatus of claim 1 wherein the vehicular shell/unibody features include:
unibody components;
sensors disposed within unibody components.

7. The apparatus of claim 6 wherein the vehicular shell/unibody features do not include:
powertrain components;
window glass;
tires and corresponding wheels;
mechanical systems.

8. The apparatus of claim 1 wherein the plurality of special circumstances that characterize repairability requirements for the vehicular shell/unibody features of the given vehicle include particular materials used to form any of the vehicular shell/unibody features.

9. The apparatus of claim 1 wherein the control circuit is further configured to identify the at least one vehicular repair facility as a further function of at least one additional selection criteria.

10. The apparatus of claim 9 wherein the at least one additional selection criteria comprises at least one of:
service hours;
replacement vehicle availability;
vehicle pickup service availability;
repaired-vehicle return service availability;
repair parts availability;
estimated repair time;
quality of service records.

11. A method to identify a vehicular shell/unibody repair facility comprising:
by a control circuit operably coupled to a network interface:
receiving via the network interface identifying information for a given vehicle and information identifying damaged vehicular shell/unibody features of the given vehicle; determining a relevant geographic location corresponding to the given vehicle;
using the identifying information and the information identifying the damaged vehicular shell/unibody features of the given vehicle to identify a plurality of special circumstances characterizing repairability requirements for the vehicular shell/unibody features of the given vehicle;
using the relevant geographic location and the plurality of special circumstances to filter information regarding a plurality of available vehicular repair facilities to thereby identify at least one vehicular repair facility that can accommodate the plurality of special circumstances and that meets a geographic convenience criterion;
transmitting via the network interface displayable information that includes identifying content regarding the at least one vehicular repair facility that can accommodate the plurality of special circumstances and that meets the geographic convenience criterion.

12. The method of claim 11 wherein the identifying information for the given vehicle comprises a 117-character vehicle identification number (VIN).

13. The method of claim 11 wherein the identifying information for the given vehicle comprises make, model, and year information for the given vehicle.

14. The method of claim 11 further comprising receiving, via the network interface, present location information for the given vehicle and wherein determining the relevant geographic location corresponding to the given vehicle comprises determining the relevant geographic location corresponding to the given vehicle as a function of the present location information.

15. The method of claim 14 wherein the present location information comprises global positioning system (GPS) information.

16. The method of claim 11 wherein the vehicular shell/unibody features include:
unibody components;
sensors disposed within unibody components.

17. The method of claim 16 wherein the vehicular shell/unibody features do not include:
powertrain components;
window glass;
tires and corresponding wheels;
mechanical systems.

18. The method of claim 11 wherein the plurality of special circumstances that characterize repairability requirements for the vehicular shell/unibody features of the given vehicle include particular materials used to form any of the vehicular shell/unibody features.

19. The method of claim 11 wherein identifying the at least one vehicular repair facility comprises identifying the at least one vehicular repair facility as a further function of at least one additional selection criteria.

20. The method of claim 19 wherein the at least one additional selection criteria comprises at least one of:
service hours;
replacement vehicle availability;
vehicle pickup service availability;
repaired-vehicle return service availability;
repair parts availability;
estimated repair time;
quality of service records.
